(19) United States
(12) Patent Application Publication
(10) Pub. No.: US 2025/0392239 A1
(43) Pub. Date: Dec. 25, 2025

(54) ELECTRICAL AMPLIFICATION SYSTEMS THROUGH RESONANCE

(71) Applicant: Andrew R. Alcon, Fort Worth, TX (US)

(72) Inventor: Andrew R. Alcon, Fort Worth, TX (US)

(21) Appl. No.: 19/179,153

(22) Filed: Apr. 15, 2025

Related U.S. Application Data
(63) Continuation-in-part of application No. 17/967,366, filed on Oct. 17, 2022, now abandoned.
Application No. 17/967,366 is a continuation-in-part of application No. 16/350,749, filed on Dec. 31, 2018, now abandoned.
(60) Provisional application No. 62/709,944, filed on Feb. 6, 2018.

(51) Int. Cl. H02P 9/04; H02J 7/32; H02J 7/34; H02K 7/18; H02K 23/04; H02K 23/66

(52) U.S. Cl. CPC H02P 9/04; H02J 7/32; H02J 7/345; H02K 7/1876; H02K 23/04; H02K 23/66

(57) ABSTRACT

An apparatus, system, and method to induce and regulate electrical energy through resonance and vibration whereby producing voltage and current generation with increased efficiency within DC electrical motors by a high frequency resonant vibration of the motor armature, including the capability to tune and control the regulation of the output current and voltage by the addition of electrical components.

### CROSS REFERENCE TO RELATED APPLICATIONS

The present application is a continuation-in-part of U.S. patent application Ser. No. 17/967,366, filed on Oct. 17, 2022, currently pending, which is a continuation-in-part of U.S. patent application Ser. No. 16/350,749, filed Dec. 31, 2018, now abandoned, which claims priority to U.S. Provisional Patent Application Ser. No. 62/709,944, filed on Feb. 6, 2018. Each of the applications listed above is hereby expressly incorporated herein by reference in their entirety.

### BACKGROUND OF INVENTION

### 1. Field of the Invention

An apparatus, system, and method produce electric current and voltage by the vibration of the electrical motors, including the capability to tune and control the output current and voltage by the addition of electrical components with predictable results.

### 2. Description of Prior Art

It is stated that it is scientifically impossible to create a “perpetual motion machine” due to factors such as friction, gravity and so forth. It is also understood that a fine line may exist between a “perpetual motion machine” and a “highly efficient machine.”

The current industry is constantly looking for effective, durable, and cost-effective methods of providing power. Thus, there is a need for a new and improved apparatus, system, and method of use for power creation. The current invention provides a result where the prior art fails.

### SUMMARY OF THE INVENTION

In view of the disadvantages inherent in the known types of power creation now present in the prior art, the present invention provides an efficient apparatus desired by the current needs. As such, the general purpose of the present invention, which will be described subsequently in greater detail, is to provide a new and improved apparatus, system, and method for power generation, which has all the advantages of the prior art and none of the disadvantages.

It has been discovered that permanent magnet DC motors, especially those having ferromagnetic elements, can utilize input of resonant vibrational power to produce electrical energy to operate the motor.

The vibrational energy acts upon the motor to provide an electrical and mechanical output. Additionally, the resonant power to the motor not only provides a mechanical output from the motor but also generates a supplemental electrical energy output from its motor terminals that can be cycled through the motor and used by an outside electrical load. The vibrational energy delivered to the DC motor is measured as a high AC voltage with a frequency in the KHz range.

It has also been found that laminated iron cores combined with insulated copper conductors can also utilize input of resonant vibrational power to produce electrical energy to power outside electrical loads. The use of diodes (to rectify the AC power to DC power), inductor or transformer coils (an electrical component comprising of a length of wire around ferromagnetic cores), capacitors (an electrical device having two conducting plate surfaces used to store charge on its plates that are separated by a dielectric insulator), and other system components are used to convert, control, and regulate the high frequency AC power produced by the resonant vibrations of the generator and or motor into DC power to run the generator and or motor and power the external load.

The present apparatus, system, and method discloses the rectification of a high voltage AC output with a frequency in the KHz range on a permanent magnet DC generator and or motor through the vibrational energy of the generator and or motor itself. The vibrational energy can be delivered to the permanent magnet generator and or motor by attaching a transformer from the circuit board and transform vibrational energy directly to the generator and or motor. The conversion potential produces an exceptionally enhanced conversion differential, from other previously unknown means. Electro-vibrational energy is demonstrated and disclosed by tuning the power output of a circuit board which is matched with the resonant frequency of the permanent magnet generator and or motor armature and conductors contained within the housing. Secondary electrical components can be used to rectify, enhance, control, and regulate the power output of the system verses the vibrational amplitude input with predictable results. If the wrong electrical values are used with certain components, the results will be a decrease in output efficiency of the system or a complete nullification of its function. However, using the same components within an optimal characteristic range will exponentially enhance the efficiency of the previously unknown and unproven electrical generation of the methods and processes.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These, together with other objects of the invention, along with the various features of novelty, which characterize the invention, are pointed out with particularity in the claims annexed to and forming a part of this disclosure. For a better understanding of the invention, its operating advantages, and the specific objects attained by its uses, reference should be made to the accompanying drawings and descriptive matter in which there are illustrated preferred embodiments of the invention.

The present invention referred to throughout may be embodied in other specific forms without departing from its spirit or essential characteristics. The described embodiments are to be considered in all respects only as illustrative and not restrictive. Furthermore, each of the methods that have been described should also be considered only as illustrative and not restrictive.

### BRIEF DESCRIPTION OF THE PICTORIAL ILLUSTRATIONS, DRAWINGS AND APPENDICES

The invention will be better understood and objects other than those set forth above will become apparent when consideration is given to the following detailed description thereof. Such description makes reference to the annexed pictorial illustrations, graphs, drawings, exhibits and appendices wherein:

FIG. 1 is a circuit diagram involving an electrical amplification system through resonance in accordance with the present invention.

FIG. 2 is an alternative embodiment of a circuit diagram involving an electrical amplification system through resonance in accordance with the present invention.

FIG. 3 shows a circuit board design which provides direct power to the resonant circuit in accordance with the present invention.

FIG. 4 shows an alternative resonant circuit charging a battery with a secondary generator in accordance with the present invention.

### DETAILED DESCRIPTION OF THE PREFERRED EMBODIMENTS

The current invention may be classified as an apparatus, system and method and or combinations thereof. The following detailed description does not define any aspect in a particular order of importance but rather attempts to organize the following for convenience only.

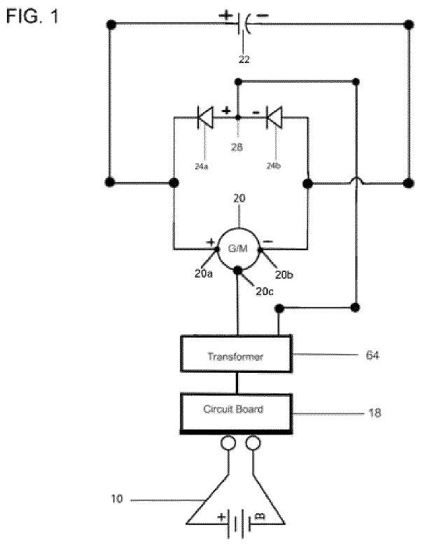

FIG. 1 is a schematic view of a ferromagnetic DC generator and or motor driver configuration 20. A circuit board 18 with a transformer 64 is shown powered by a battery 10. The transformer 64 terminals directly connect to a conductive surface 20c of the ferromagnetic DC generator and or motor 20 and a junction 28 between two diodes 24a and 24b. The diode 24a is connected to a positive terminal 20a of generator and or motor 20 and the diode 24b is connected to a negative terminal 20b of generator and or motor 20 forming a closed circuit between the terminals of the generator and or motor 20. The positive terminal 20a of the generator and or motor 20 is connected to a positive terminal of capacitor 22. The negative terminal 20b of the generator and or motor 20 is connected to the negative terminal of capacitor 22. When the circuit board 18 is turned on and tunes the transformer 64 to the resonant frequency of the generator and or motor 20, the generator and or motor 20 rotates itself without a prime mover under this configuration and charges capacitor 22. The resonant frequency is obtained by viewing the maximum amperage drawn through an amp meter at any given power to the circuit board 18. The direction of the motor rotation is determined by diode direction connecting the motor terminals. If the direction of the diode configuration is reversed between the motor terminals, the shaft rotation will reverse relative to the terminals facing the brush assembly.

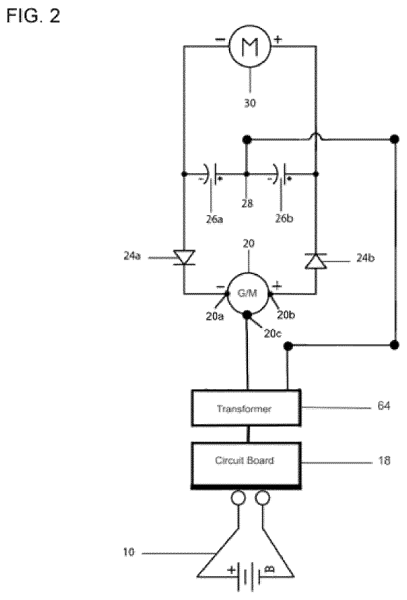

FIG. 2 shows circuit board 18 and transformer 64 is designed to operate at a variable frequency output from the circuit board 18. The resonant frequency of the output circuit connects between the conductive surface 20c of the generator and or motor 20 and the junction 28 between a capacitor 26a and a capacitor 26b. The capacitors 26a and 26b are wired together in series and are connected to the electrical terminals 20a and 20b of motor 20. When the circuit is energized and the generator and or motor 20 conductive surface 20c is positive and the junction 28 is negative, current flows from terminal 20b through diode 24b to charge capacitor 26b. When the circuit reverses polarity and the generator and or motor 20 conductive surface 20c is negative and the junction 28 is positive, current flows from terminal 20a through diode 24a to charge capacitor 26a. Capacitors 26a and 26b deliver their power to a motor 30, which draws their charging current from the generator and or motor 20. The power of the generator and or motor 20 is determined by the input power of circuit board 18 and the tuned output frequency of the transformer 64 powering the circuit at its resonant frequency. The generator and or motor 20 operates exactly the opposite of a conventional DC generator. The greater the electrical current output that it delivers as a generator to a load, the greater the mechanical torque output that it delivers through its shaft as a motor at any given power input from the transformer 64.

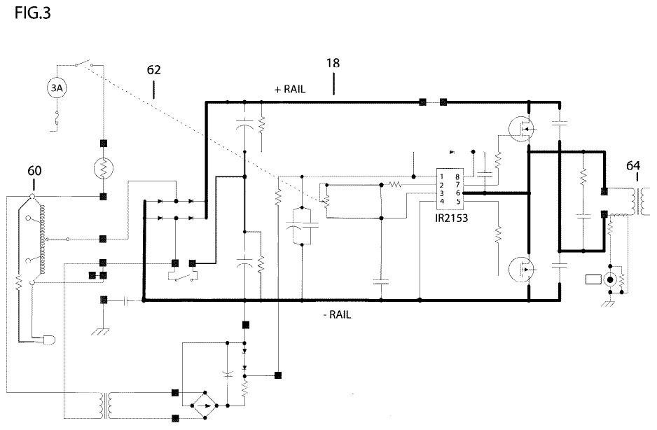

FIG. 3 shows the circuit board 18, which provides direct power to the resonant circuit. The circuit board 18 is provided with a variable transformer 60 for power control and a variable resistor 62 for frequency control. The output transformer 64 delivers the resonant frequency to the circuit. The circuit board 18 may be powered by a DC to AC power inverter (not seen), which is powered by a battery or capacitor array. The circuit board 18 can also be powered by a direct current source (not seen). The resonant frequency of the circuit receiving the power from the output transformer 64 is found by monitoring the power of the electrical amperage drawn by the variable transformer 60 to the circuit board 18 from the power inverter through the use of a watt meter (not shown). The resonant frequency is tuned in by adjusting the resistance of the variable resistor 62. The resonant frequency of the circuit is obtained when maximum amperage is drawn by the variable transformer 60 to the circuit board 18 from any fixed power setting of the variable transformer 60.

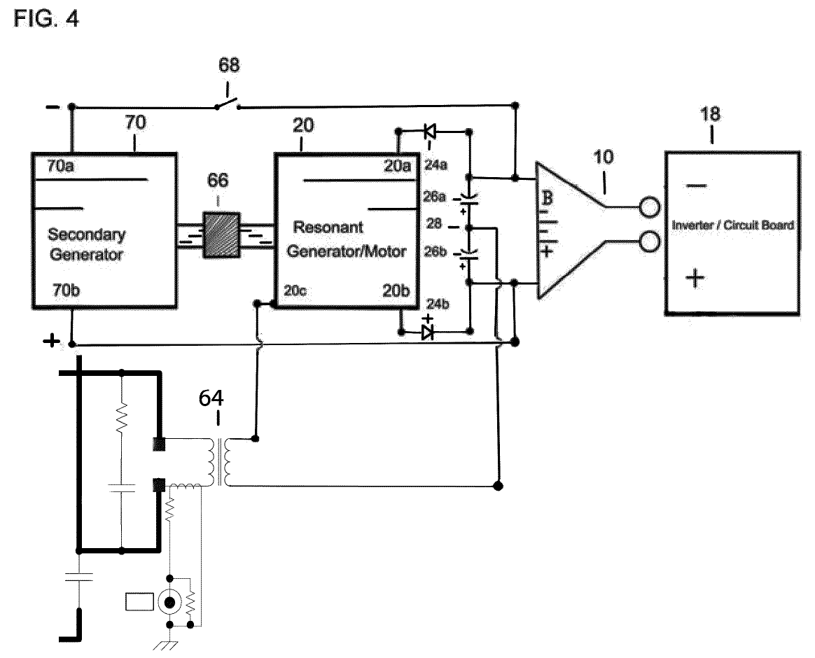

FIG. 4 shows an alternative resonant circuit charging battery 10. The output transformer 64 is connected to the electrically conductive surface 20c of the resonant generator and or motor 20 and the junction 28 between capacitor 26a and capacitor 26b. When the output transformer 64 is energized with a high frequency AC output, the electrically conductive surface 20c of resonant DC generator and or motor 20 is electrically polarized and outputs electrical energy to separately charge capacitor 26a and capacitor 26b as the voltage switches polarity within the output transformer 64. When the resonant generator and or motor 20 conductive surface 20c is electrically negative and junction 28 is positive, electrical current will flow from terminal 20a through diode 24a to charge capacitor 26a. When the resonant generator and or motor 20 conductive surface 20c is electrically positive and junction 28 is negative, electrical current will flow from terminal 20b through diode 24b to charge capacitor 26b. Capacitor 26a and capacitor 26b are serially connected together and they transfer their combined voltage through the high frequency charging process to charge battery 10. When electrical current flows from the resonant DC generator and or motor 20 to charge the capacitors 26a and 26b, which are connected to battery 10, the motor shaft of the resonant generator and or motor 20 develops rotational torque which can be used to rotate a secondary generator 70 that is coupled to the resonant generator and or motor 20 through a non-conductive coupling 66 connecting the two motor shafts together. The secondary generator 70 rotates to produce output voltage to power an additional load from its terminals 70a and 70b. If the additional load connected to the secondary generator 70 is battery 10, a switch 68 is included in the circuit to provide the option to open and close the circuit.

### SINGLE COMMUTATOR GENERATOR

FIG. 1 is identified as another embodiment of an apparatus which produces electrical current and voltage by the vibration of a DC electrical generator and or motor 20. This apparatus utilizes the single ferromagnetic electric DC generator and or motor 20, which produces electric current and voltage through a plurality of diodes, which transfers the current and voltage through the diode bridge junction in the manner shown. Between the diodes comprising the diode bridge junction is a wire, which alternates voltage back to the transformer to provide a power circuit between the DC generator and or motor 20 windings and the diode bridge junction. The ferromagnetic DC generator and or motor 20 of this first embodiment produces the voltage and amperage generated solely by the electrical forces of the transformer and also induces the spin of the DC generator and or motor shaft within the ferromagnetic electrical DC generator and or motor 20, thereby creating a mechanical rotation as well as a contemporary electrical output current circulating from the DC generator and or motor terminals through the diodes. The DC generator and or motor terminals are connected to a capacitor, which charges the capacitor when mechanical rotation occurs in the DC generator and or motor 20. The stator field of the ferromagnetic DC generator and or motor 20 can be provided by a permanent magnet, electromagnet, or superconducting magnet.

### DOUBLE MOTOR CIRCUIT

FIG. 2 is identified as an embodiment of an apparatus, which produces electrical current and voltage by the electrical vibration of a magnetic DC electrical generator and or motor 20. This apparatus utilizes the two or more magnetic DC electric generator and or motors that produce electric current and voltage through a series of diodes, which transfer the current through the diode bridge in the manner shown. Also used is a pair of electrolytic capacitors located within the center of the diode bridge-one prior to and one subsequent to the intersecting wire connection through a circuit leading back to the transformer connected to the circuit board supplying supplemental electrical voltage to and from the transformer. Once again, the first ferromagnetic generator and or motor produces high voltage output, generated solely by the electrical forces and also induces the spin of a motor shaft within the first ferromagnetic electrical generator and or motor as it delivers power to an outside electrical load by rectifying the high frequency and or high voltage AC power to DC power, thereby creating a mechanical force as well as a contemporary electrical current at a high voltage. The power to the second ferromagnetic motor draws output power from the first ferromagnetic generator and or motor through the capacitors in the circuit causing the rotation of its motor shaft. The operational voltage and power of the second ferromagnetic motor is directly related to the voltage placed upon the capacitors from the resonant voltage produced from the first ferromagnetic generator and or motor, which is transferred to the capacitors through the diodes. It is further observed that placing a load on the spinning motor shaft of the second ferromagnetic motor increases the rotational RPM of the first ferromagnetic electrical generator and or motor and that limiting the rotation of the shaft of the second ferromagnetic motor, the voltage generated by the first ferromagnetic electric generator and or motor appears to be reflected back to itself. Thus far, the power enhancement is unmeasured and appears to have no limit potential when scaled up in size. This second embodiment is useful in operating one or more apparatuses, which require a rotary shaft for mechanical power and also is useful in operating an apparatus, which requires a charging voltage electrical output, including fuel cells, hydrogen cells and other appliances. The stator field of the ferromagnetic DC generator and or motor can be provided by a permanent magnet, electromagnet, or superconducting magnet.

### CIRCUIT BOARD DESIGN FOR VARIABLE FREQUENCY AND POWER OUTPUT

FIG. 3 shows a circuit board design, which provides direct power to the resonant circuit. The circuit board is provided with a variable transformer for power control and a variable resistor for frequency control. The transformer output coil delivers the resonant frequency to the circuit.

### ALTERNATIVE RESONANT CIRCUIT DIRECTLY CHARGING A BATTERY

FIG. 4 shows an alternative resonant circuit directly charging battery 10. The resonant generator and or motor 20 outputs electrical energy to charge the capacitors, which transfers their additional charge to the battery. When electrical current flows from the resonant generator and or motor to charge the capacitors, which are connected to the battery, the motor shaft of the resonant generator and or motor develops rotational torque, which can be used to rotate a secondary generator, which is coupled to the resonant generator and or motor through a non-conductive coupling connecting the two motor shafts together.

### PERFORMANCE AND UTILITY

Early experiments observed by the applicant had been performed on vibrating ferrite core inductors over a number of years leading up to the present invention. The experiments included using DC power sources such as a battery, a DC generator, or a DC power supply. The experiments included using high speed transistors, which were powered through a signal generator to deliver square wave pulses of DC power into numerous inductors of varying values from mill-henrys to micro-henrys. The pulses would produce an AC square wave signal in the inductor when the transistor was turned on and off as it delivered pulsed electrical power to the coil. The resonant frequency of each coil could be determined by measuring the DC voltage from two diodes attached on the wires on either end of the inductor. When the peak voltage was measured from the collapsed field of the inductors on the DC side of the diodes then the system would be in a state of tuned resonance. Each inductor value had a resonant frequency related to its value. The higher the inductor value was, the lower its resonant frequency would be. The lower the inductor value was, the higher its resonant frequency would be. It was observed that very high DC voltages could be obtained through the use of diodes on the inductors from the input of pulsed low DC voltages at the resonant frequency of the inductor coil. Other observations showed that the addition of a capacitor to collect the voltage from the diode would significantly increase the measured voltage even further. The capacitor would charge to a higher voltage than the output voltage measured at the diodes. It is believed that the resonant DC voltage from the diodes aided the capacitors to charge to a higher DC voltage than the measured voltage from the diodes. Multiple experiments were performed to collect data. In one experiment, a 1.5-volt AA battery was used as a power source and a high-speed transistor was placed in the circuit to turn on and off at a predetermined frequency which provided a pulsed voltage and current to the ferrite inductor coil. As the frequency was tuned to the resonance of the coil, the measured voltage on the DC side of the diode would increase and peak at the resonance of the coil. The tuned voltage measured above 250 volts on the DC side of the diodes from 1.5 volts of input power into the inductor coil. When we attached a 0.015 mfd capacitor to the DC side of the diode, the voltage measured in excess of 500 volts from the resonant coil. We performed another experiment in which a DC power supply was used as a power source to send pulses through a transistor into a 30 mH inductor at a predetermined frequency and voltage. We used a diode connected to the inductor to charge a 390 mfd-400-volt electrolytic capacitor which was connected to run a 180-volt DC generator and or motor. Performance values were taken comparing other inductor core materials to iron such as high frequency ferrite materials. It is also anticipated that other enhanced materials which possesses high mechanical resonance properties may be added in future embodiments of the present invention without departing from the spirit and scope of the present invention.

### TEST AND EXAMPLES

The utility of this device which produces electrical current and voltage by the vibration of an electrical motor is as follows. First, we are able to generate electrical energy from an electrical generator and or motor without direct electrical input or any mechanical force rotating the motor shaft, other than through vibration of the motor. Second, we are able to generate mechanical forces plus the electrical energy, wherein the electrical energy output is actually transferred when a mechanical load is placed on the motor. Third, we are able to include mostly passive electrical components to regulate a predictable quantity of electrical energy and mechanical energy output, with enough energy returned to the system to reduce the amount of energy required to continually operate the system to near minimum. Fourth, we are able to create a useful power source to operate multiple apparatuses which require high voltage at low current with a minimum amount of input energy. Other useful benefits can be achieved using the basic physical and mechanical implications found within the scope of this disclosed operational system and relevant subject matter which are previously unknown and had not been discovered until such time as the disclosure of the present invention.

Although the various embodiments of the invention have been described and shown above, it will be appreciated by those skilled in the art that numerous modifications may be made therein without departing from the scope of the invention as herein described. Changes may be made in the combinations, operations, and arrangements of the various parts and elements described herein without departing from the spirit and scope of the invention.

I claim:

1. An apparatus for production of electrical current, voltage, and mechanical power by a tuned and selected vibration, said apparatus comprising:
a battery defining a positive terminal and a negative terminal, attached to an inverter and a circuit board providing power to conduct electro-mechanical energy through a transformer;
a DC generator and or motor, electrically connected with an electrically conductive surface to said transformer powered by said circuit board causing said DC generator and or motor to operate by said electro-mechanical energy of said transformer, converting said electro-mechanical energy from said circuit board into operation of said DC generator and or motor, producing said electrical current and said voltage to a first and a second terminals of said DC generator and or motor upon commencement of operation of said circuit board;
a diode connected to said first terminal of said DC generator and or motor and facing toward said first terminal of said DC generator and or motor and connected to a negative terminal of a first capacitor;
a diode connected to said second terminal of said DC generator and or motor and facing away said second terminal of said DC generator and or motor and connected to positive terminal of a second capacitor, with said first and said second capacitors are attached to one another at a common junction;
wherein said negative terminal of said battery is connected to said negative terminal of said first capacitor, and said positive terminal of said battery is connected to said positive terminal of said second capacitor;
a circuit wiring between said junction of said first capacitor and second capacitors and said transformer of said circuit board; and
wherein said electro-mechanical energy generates said current and said voltage from said DC generator and or motor through said diodes connected to said first and second terminals of said DC generator and or motor, causing said DC generator and or motor to rotate an armature shaft and returning said current and said voltage to said first and second capacitors connected to said battery.

2. The apparatus of claim 1 wherein said circuit board is provided with a variable transformer for power control, a variable resistor for frequency control and an output transformer to provide output power to the resonant circuit.

3. The apparatus of claim 1 wherein said first resonant generator and or motor is a ferromagnetic permanent magnet DC generator and or motor.

4. The apparatus of claim 1 wherein said first resonant generator and or motor is a ferromagnetic electro-magnet DC generator and or motor.

5. The apparatus of claim 1 wherein said first resonant generator and or motor is a ferromagnetic superconducting magnet DC generator and or motor.

6. The apparatus of claim 1 further comprising:
a non-electrically conductive coupling connecting the shaft of a secondary generator to the shaft of the resonant generator and or motor producing additional electrical current and voltage as the resonant generator and or motor rotates the shaft of the secondary generator; and
the terminals and of the secondary generator are provided with a switch to regulate the power flowing from the secondary generator to the positive and negative terminals of battery.

7. An apparatus for production of electrical current, voltage, and mechanical power by a tuned and selected vibration, said apparatus comprising:
a battery defining a positive terminal and a negative terminal, attached to an inverter and a circuit board providing power to conduct electro-mechanical energy through a transformer;
a DC generator and or motor, electrically connected with an electrically conductive surface to said transformer powered by said circuit board causing said DC generator and or motor to operate by said electro-mechanical energy of said transformer, converting said electro-mechanical energy from said circuit board into operation of said DC generator and or motor, producing said electrical current and said voltage to a first and a second terminals of said DC generator and or motor upon commencement of operation of said circuit board;
a diode connected to said first terminal of said DC generator and or motor and facing toward said first terminal of said DC generator and or motor and connected to a positive terminal of a capacitor;
a diode connected to said second terminal of said DC generator and or motor and facing away said second terminal of said DC generator and or motor and connected to negative terminal of capacitor,
a circuit wiring between said junction of said first diode and second diode and said transformer of said circuit board; and
wherein said electro-mechanical energy generates said current and said voltage from said DC generator and or motor through said diodes connected to said first terminal and second terminal of said DC generator and or motor, causing said DC generator and or motor to rotate an armature shaft and returning said current and said voltage to said first terminal and second terminal connected to capacitor.

8. The apparatus of claim 5 wherein said circuit board is provided with a variable transformer for power control, a variable resistor for frequency control and an output transformer to provide output power to the resonant circuit.
